(19) United States
(12) Patent Application Publication
(10) Pub. No.: US 2020/0041026 A1
(43) Pub. Date: Feb. 6, 2020

(54) ELECTROMAGNETIC PRESSURE CONTROL VALVE

(71) Applicant: ECO Holding 1 GmbH, Marktheidenfeld (DE)

(72) Inventors: Manuel Braun, Nuertingen (DE); Viktor Unruh, Steinhagen (DE); Eike - Nils Winzer, Nuertingen (DE)

(21) Appl. No.: 16/510,936

(22) Filed: Jul. 14, 2019

(30) Foreign Application Priority Data
Aug. 1, 2018 (DE) DE102018118671.1
Jun. 24, 2019 (DE) DE102019116863.5

(51) Int. Cl. F16K 31/06

(52) U.S. Cl. CPC F16K 31/0696; F16K 31/0613

(57) ABSTRACT

An electromagnetic pressure control valve, comprising: an electromagnetic actuator configured to position a piston that is received axially movable in a receiving opening of a controller housing, wherein the piston facilitates opening or closing flow connections of the electromagnetic pressure control valve, wherein the piston includes a pin at a face that is oriented away from the electromagnetic actuator, wherein a relative movement is enabled between the pin and the piston, wherein a surface of the pin that is arranged in the controller housing and oriented away from the piston is arranged opposite to a stop, wherein the pin is spring loaded to contact the stop so that a movement of the pin in a direction towards the stop is prevented, and wherein a preload element that is configured to provide the spring loading engages the pin.

### RELATED APPLICATIONS

This application claims priority from German patent applications

DE 10 2018 118 671.1 filed on Aug. 1, 2018 and
DE 10 2019 116 863.5 filed on Jun. 24, 2019,
both of which are incorporated in their entirety by this reference.

### FIELD OF THE INVENTION

The invention relates to an electromagnetic pressure control valve according to the preamble of patent claim 1.

### BACKGROUND OF THE INVENTION

Electromagnetic pressure control valves are known in the art. They are used, for example, for hydraulically controlling a clutch of an automatic transmission of a motor vehicle. The pressure control valves include a piston that is axially movable in a controller housing and that is provided for opening and/or closing connections. The piston is moved axially by an electromagnetic actuator. In order to adapt an actuation force of the electromagnetic actuator, the pressure control valve includes a pin at a piston end that is oriented away from the electromagnetic actuator wherein the pin is also designated as a needle and received in a receiving opening of the piston. The pin contacts a wall of the controller housing that is arranged opposite to the piston end and forms a stop for the pin. The movement of the piston causes a relative movement between the piston and the pin. An electromagnetic pressure control valve of this type can be derived from the two publication documents, DE 102 41 449 A1 and EP 1 762 765 A2.

The axial movement of the piston changes a volume that is formed between the pin and the receiving opening which provides a damping of the piston movement since the volume is at least partially filled with hydraulic fluid. Thus, a force equilibrium can be provided at the piston. However, there are load conditions during operation of the pressure controller or pressure oscillations in the connections which cause a lifting of the pin from the wall when the magnet is loaded with current so that the piston is moved.

Also oscillations exclusively from the system can excite static the pressure control valve negatively so that the pin lifts off from the wall.

It causes a problem when the pin is subjected to a very high acceleration and impacts the wall. This, in turn, causes damages to the wall through fracture, or when the wall is inserted into the controller housing, it causes the wall to be jolted out of the controller housing which causes a failure of the pressure control valve.

### BRIEF SUMMARY OF THE INVENTION

Thus, it is an object of the instant invention to provide an improved electromagnetic pressure control valve which eliminates the operational problems recited supra.

The object is achieved according to the invention by an electromagnetic pressure control valve inlcuidng an electromagnetic actuator configured to position a piston that is received axially movable in a receiving opening of a controller housing, wherein the piston facilitates opening or closing flow connections of the electromagnetic pressure control valve, wherein the piston includes a pin at a face that is oriented away from the electromagnetic actuator, wherein a relative movement is enabled between the pin and the piston, wherein a surface of the pin that is arranged in the controller housing and oriented away from the piston is arranged opposite to a stop, wherein the pin is spring loaded to contact the stop so that a movement of the pin in a direction towards the stop is prevented, and wherein a preload element that is configured to provide the spring loading engages the pin. Advantageous embodiments with useful and non-trivial improvements of the invention are provided in the respective dependent claims.

An electromagnetic pressure control valve according to the invention includes an electromagnetic actuator for positioning a piston that is received axially movable in a receiving opening of a controller housing. The piston facilitates opening and/or closing flow connections of the pressure control valve. The piston includes a pin at a face that is oriented away from the electromagnetic actuator, wherein a relative movement is enabled between the pin and the piston. A face that is configured in the controller housing and oriented away from the piston is arranged opposite to a stop according to the invention. In order to prevent a movement of the pin in a direction towards the stop the pin is configured spring loaded wherein a preload element that is configured to provide the spring preload engages the pin.

This means put differently that the pin contacts the stop independently from pressures applied to the pressure control valve due to the preload element. Thus, a preload force is introduced which can also be designated as a spring force which prevents a lift off of the pin from the stop. Due to the introduced spring force a lift off and impact of the pin at the stop is also prevented under unfavorable pressure conditions so that damages are prevented. This provides an improved electromagnetic pressure control valve with an increased service life.

In one embodiment of the electromagnetic pressure control valve according to the invention the preload element is supported at the piston and at the pin. Thus, the preload element can be used to reset the piston and to contact the pin at the stop.

In a compact embodiment the preload element that is advantageously configured as a coil spring envelops the pin.

In order to safely arrange the preload element at the pin the pin includes at least a first diameter and a second diameter wherein the first diameter is smaller than the second diameter and wherein the second diameter is associated with a pin head or a pin shoulder where the preload element can be supported.

The pin head is configured to contact the stop. Thus the pin can be produced in a simple manner, e.g. mushroom shaped. This means put differently that the pin head has a larger diameter of the pin and therefore does not have any undercuts that need to be produced which would require a complex shape.

In order to reduce hysteresis influences e.g. by angular deviations between the stop and the pin the stop is configured as a point or line contact. The point or line contact can be simply implemented in that the pin head oriented towards the stop or the stop oriented towards the pin head is configured spherical or convex.

According to an embodiment of the invention that is producible in a particularly cost effective manner the pin can have a single diameter and be supported with a pin face at the stop and with another pin face at the preload element, wherein the preload element is configured between the piston and the pin.

In order to reduce hysteresis influences e.g. caused by angular deviations between the stop and the pin the stop is configured as a point or line contact. The point or line contact can be simply implemented in that the stop includes a spherical or convex protrusion where the pin contacts. The stop can be produced in one piece or also in several pieces.

A cost effective electromagnetic pressure control valve can be provided by producing the pin from a synthetic material. In addition to facilitating reduced material cost effective methods like deep drawing or injection molding can be used.

In order for a variable volume that is filled with hydraulic fluid and defined between the stop and a face of the piston that is oriented towards the stop not to cause a lift off of the pin from the stop during a movement of the piston, the controller housing includes a relief opening, in particular in the portion of the preload element, wherein the relief opening is flowable by the variable volume.

In another embodiment the stop includes a flowable opening. Using the flowable opening another control element can be used to adjust the pressure in the variable volume that is configured between the stop and the face of the piston that is oriented towards the stop so that the relief is adaptable to corresponding operating conditions of the electromagnetic pressure control valve. Thus, a flowable tank connection can be implemented with the flowable opening.

The relief opening is arranged as a function of an installation condition of the electromagnetic pressure control valve. The advantage of this embodiment is that the relief opening of the electromagnetic pressure control valve does not always have to be configured at the same location at the pressure control valve. The relief opening only has to be arranged so that a secured filling an emptying of the adjustable volum that is formed between the piston and the cover is implemented. Thus, the predetermined installation position and the available installation space can be taken into consideration.

In another embodiment of the electromagnetic pressure control valve according to the invention the stop is configured as a cover that closes the first receiving opening. Thus, an economical pressure control valve can be produced since the first receiving opening can be implemented as an economical bore hole. Furthermore the preload element and the pin can simply be arranged in the first receiving opening before mounting the cover so that a cost effective assembly is assured.

Using a bevel at an outer circumference of an element face of the cover that is oriented towards the pin facilitates a simple assembly of the cover. The bevel facilitates insertion of the cover into the controller housing.

In another embodiment of the electromagnetic pressure control valve according to the invention the cover is secured at the controller housing by at least one clamping element.

In order to advantageously secure the cover at the controller housing using the clamping element an element face of the cover that is oriented away from the piston is configured rounded. This simplifies engagement of the clamping element in the cover in particular when the cover has a receiving opening at an element face that is oriented away from the piston.

The instant electromagnetic pressure control valve according to the invention therefore has increased service life independently from the stop being provided as a wall that is bonded to the controller housing or as a cover that is friction locked by a press fit since an acceleration of the pin and thus an impact at the stop is prevented.

The instant invention also prevents a lift off of the pin besides preventing a hard impact since the movement impulse of the pin is prevented in both directions using the preload force. Effects through dynamic interferences and pressure oscillation superpositions are thus effectively eliminated in both directions. Thus, the cause of the failure of the electromagnetic pressure control valve is already prevented in the onset.

### BRIEF DESCRIPTION OF THE DRAWINGS

Further advantages, features and details of the invention can be derived from the subsequent description of advantageous embodiments and from the drawing figure. The features and feature combinations recited in the preceding description and recited in the subsequent figure description and/or features and feature combinations that are shown in the drawing figures are not only usable in the respectively stated combination but also in other combinations or by themselves without departing from the spirit and scope of the invention. Identical reference numerals are associated with identical or functionally equivalent elements. In order to provide clarity it is possible that the elements are not provided with reference numerals in all drawing figures without losing the association, wherein:

FIG. 1 illustrates a longitudinal sectional view of a prior art electromagnetic pressure control valve;

FIG. 2 illustrates a longitudinal sectional view of an electromagnetic pressure control valve according to the invention in a first embodiment;

FIG. 3 illustrates a longitudinal sectional view of a hydraulic unit of the electromagnetic pressure control valve according to FIG. 2;

FIG. 4 illustrates a longitudinal sectional view of the electromagnetic pressure control valve in a second embodiment; and

FIG. 5 illustrates a longitudinal sectional view of the electromagnetic pressure control valve according to the invention in a third embodiment.

### DETAILED DESCRIPTION OF THE INVENTION

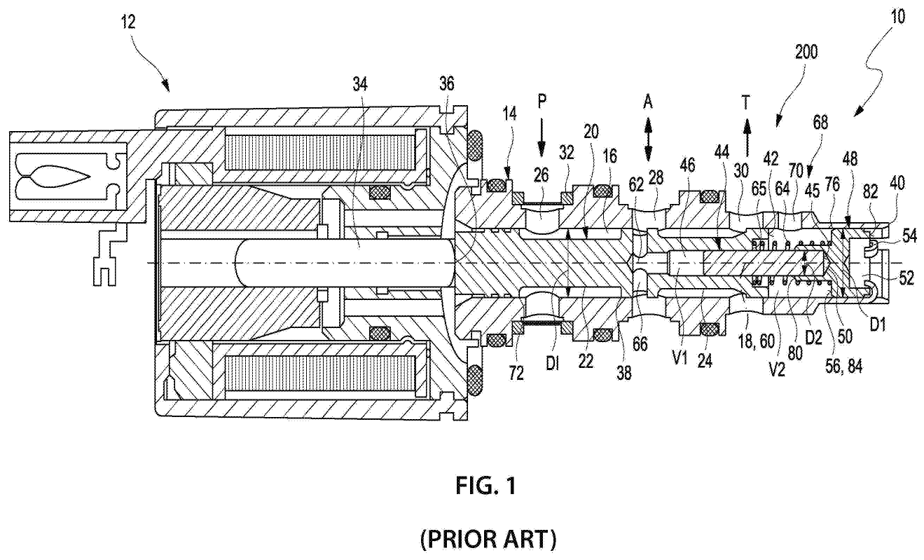

A prior art electromagnetic pressure control valve 10 for a clutch of an automatic transmission of a motor vehicle that is not illustrated in detail is configured according to FIG. 1. The pressure control valve 10 is illustrated in FIG. 1 in a first position in which the electromagnetic actuator of the pressure control valve 10 that is not illustrated in detail is not loaded with electrical current.

The pressure control valve 10 includes a controller housing 14 which is configured to be connected with hydraulic connections, a supply connection P, a consumer connection A and a tank connection T. A piston 20 is movably received in a first receiving opening 16 configured in the controller housing 14 so that the piston is axially movable along a longitudinal axis 18 of the controller housing 14. The controller housing 14 is configured rotation symmetrical with respect to the longitudinal axis 18.

The piston 20 is configured to provide a controllable flow through of the hydraulic connections P, A, T. The piston includes two control grooves that are configured over its circumference, a first control groove 22 and a second control groove 24. The first control groove 22 is configured to provide a flow connection between the supply connection P and the consumer connection A. The second control groove 24 is configured to provide a flow connection between the consumer connections A and the tank connection T.

In order to provide the flow connection the controller housing 14 includes flow through openings that are arranged in series along the longitudinal axis 18 and completely penetrate the controller housing 14, wherein a first flow through opening 26 is associated with the supply connection P, a second flow through opening 28 is associated with the consumer connection A, and a third flow through opening 30 is associated with the tank connection T. A filter screen 32 is received in the first flow through opening 26 wherein the filter screen facilitates filtering a hydraulic fluid that flows through the pressure control valve 10 and that is provided to the pressure control valve 10 through the supply connection P.

In order to position the piston 20 the electromagnetic actuator 12 is provided with an axially movable plunger 34 which assumes an axial position according to a current loading of the electromagnetic actuator 12. FIG. 1 illustrates the electromagnetic actuator 12 in a condition without current loading and the plunger 34 is in an idle position. The plunger 34 contacts the piston 20 at a plunger end 36 that is oriented towards the piston 20. Thus the piston 20 also performs an axial movement when the plunger 34 is moved.

In a second position of the pressure control valve 10 that is not illustrated in more detail the consumer connection A is loaded with the hydraulic fluid from the supply connection P. The piston 20 is then positioned by the plunger 34 so that the first control groove 22 releases the first flow through opening 26 and the second flow through opening 28. The first control edge 38 of the first control groove 22 which is oriented towards the second flow through opening 28 is moved far enough axially in a direction towards a housing end 40 of the controller housing 14 that is oriented away from the electromagnetic actuator so that the second flow through opening 28 can be flowed through since a second control edge 72 of the first control groove 22 that is arranged opposite to the first control edge 38 is positioned so that the first flow through opening 26 is released.

The piston 20 includes a cylindrical pin 44 at a face 42 that is oriented towards the housing end 40 wherein the pin 44 is received in a second receiving opening 46 that is configured in the piston 20. The pin 44 is positioned in the second receiving opening 46, in particular movable relative to the piston 20 and coaxially supported relative to the piston 20. The pin 44 is restricted in its axial movement in an axial direction that is oriented away from the piston 20 through a cover 48 that is arranged opposite to the pin face 45. The pin 44 undergoes accelerations as a function of pressure conditions applied to the pressure control valve 10.

A variable first volume V1 is configured between the second receiving opening 46 and the pin 44, wherein the variable first volume facilitates damping the piston movement. In order to supply the first volume V1 with hydraulic fluid the piston 20 includes inlet openings 66 at an end portion 62 of the second receiving opening 46 that is arranged opposite to the pin 44. The inlet openings 66 are configured in the piston 20 so that a feeding and draining of the first volume V1 can be provided with hydraulic fluid through the consumer connection A. Overall two inlet openings 66 are arranged evenly distributed over a circumference of the piston 20. By the same token also more inlet openings 66 or only a single inlet opening 66 can be provided.

The pin 44 is supported at the cover 48 that is configured as a stop, wherein the pin engages a third receiving opening 50 that is associated with the cover 48 and configured coaxial with the longitudinal axis 18. In addition to receiving the pin 44 the cover 48 closes the first receiving opening 16 at the housing end 40, put differently this means that the cover 48 seals the controller housing 14 essentially tight.

From the third receiving opening 50 which is configured at a first element face 80 of the rotation symmetrical cover 48 the cover 48 includes a fourth receiving opening 52 at a second element face that is oriented away from the first element face 80.

The cover 48 is configured semi-hollow cylindrical and includes a section 68 along a cover axis 60 that is configured coaxial with a longitudinal axis 18 wherein the section 68 has a diameter D1 and the cover has an additional section with a second diameter D2, wherein the first diameter D1 is greater than the second diameter D2. The first diameter D1 essentially corresponds to an inner diameter DI of the first receiving opening 16. Advantageously the first diameter D1 is configured to generate a press fit between the controller housing 14 and the cover element 48. An additional safety against disengagement of the cover element 48 is configured in a form of clamping elements 54 which engage the third receiving opening 52 starting from the controller housing 14.

Due to the two diameters D1, D2 the cover 48 includes a shoulder 56 with a shoulder surface 84. A compressible second volume V2 is configured between the shoulder 56 which is oriented towards the piston 20, the piston 20 and the controller housing 14. In order to provide a controlled movement of the piston along its travel path and in order to reset the piston 20 in a direction towards the electromagnetic actuator a preload element 64 is arranged between the piston 20 and the cover element 48 wherein the preload element is configured in this embodiment as a coil spring.

The preload element 64 is supported at one end at the shoulder 56 and at the other end at the piston 20. In order to provide safe positioning the preload element 64 is received at the other end in the second receiving opening 46 and supported there at an additional shoulder 65 which is configured in the piston 20.

In addition to supporting the preload element 64 the additional shoulder 65 limits the axial piston movement since the additional section protrudes into the second receiving opening 46 and is contactable at the additional shoulder 65.

Supporting a prevention of the lift off of the pin 44 from the cover 48 the pressure control valve 10 according to the invention includes a hydraulic end position damper 68 in order to dampen a movement of the pin 44 in a direction towards the cover 48. The hydraulic end position damping 68 is characterized in that the pin 44 is hydraulically supported at an end that is oriented away from the piston 20. The hydraulic support is configured so that a force is applied by hydraulic fluid that is provided between the pin face 45 that is oriented towards the cover 48 and the cover wherein the force counteracts the movement of the pin 44 so that the movement of the pin 44 is dampened.

In order to relieve the second volume V2 a relief opening 70 is configured in the controller housing 14 wherein the relief opening is configured in the illustrated embodiment in the controller housing 14 adjacent to the tank connection T as a flowable bore hole. The relief opening 70 provides a flowable connection between the second volume V2 and the tank connection T.

The relief opening 70 is configured at the pressure control valve 10 so that the second volume V2 is completely filled with hydraulic fluid. In the illustrated embodiment the illustrated horizontal position of the pressure control valve 10 corresponds to its installed condition. Thus, the relief bore hole 70 is arranged above the pin 44 and the cover 48 at an angle of 90 degrees relative to the longitudinal axis 18 in order to provide safe filling of the second volume V2.

In an embodiment that is not illustrated in detail the relief bore hole 70 is flow connected with another connection to the tank connection T so that the relief bore hole 70 is independently positioned. This means put differently that the assembly of the pressure control valve 10 can be performed independently from a positional orientation of the relief opening 70 while simultaneously assuring a complete filling of the second volume V2.

The cover 48 includes a bevel 76 at an outer circumference of the shoulder surface 84 in order to provide quick assembly so that the cover 48 can be inserted more easily. In order to provide simple and secure reception of the clamping elements 54 the second element face 82 is cambered in a direction towards the clamping elements 54.

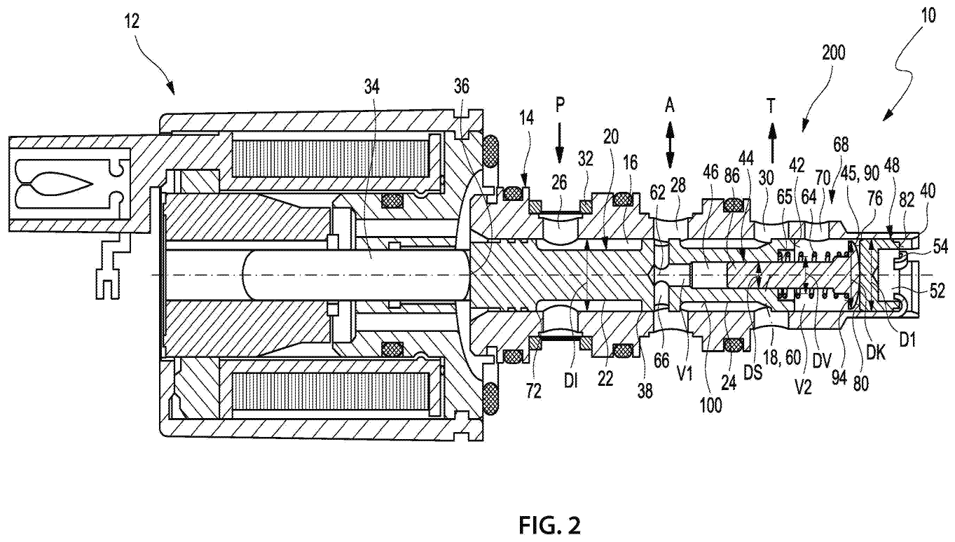

The pressure control valve 10 according to the invention which is configured according to FIG. 2 includes a preload element 64 to reliably prevent a lifting of the pin 44 from the stop 48 wherein the preload element engages the pin 44. Thus, the pin is pressed against the cover 48 under all pressure conditions that are provided at the pressure control valve 10 using the inherent preload in the preload element 64, wherein the preload element 64 has to be configured for the maximum pressure conditions.

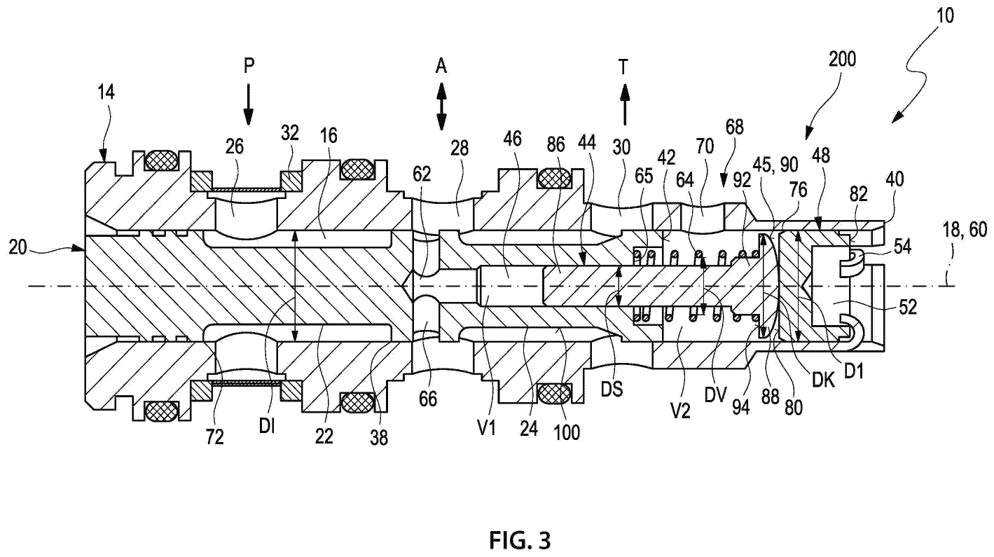

In order to allow a better description a hydraulic unit 200 of the electromagnetic control valve 10 is illustrated in FIG. 2, comprising the controller housing 14, a piston 20, the pin 44, and the cover 48 in a blown up view in FIG. 3.

The preload element 64 is thus supported at the piston 20 at a shoulder 65 oriented towards the cover 48 and at the pin 44. Accordingly the resetting of the piston 20 is still performed by the preload element 64 wherein the pin 44 is simultaneously pressed against the cover 48 due to the preload force. This means put differently that the preload element 64 can expand in both directions when the piston 20 is reset in a direction oriented away from the cover 48, wherein the preload element presses at one end against the piston 20 and at another end against the pin 44 due to the preload.

The pin 44 of the electromagnetic pressure control valve 10 in the first embodiment includes a cylindrical pin section 86 with a pin diameter DS and a pin head 88 that is configured in one piece with the pin section 86 and that has a head diameter DK, wherein the head diameter DK is configured greater than the pin diameter DS.

The pin head 88 is configured spherical towards the cover 48. This means put differently that a head surface 90 that is oriented towards the cover 48 is configured spherical. By the same token the pin head 88 can also be configured convex. The head surface 90 is the surface of the pin 44 that contacts the cover 48 corresponding to the pin face 45.

The pin 44 includes a pin shoulder 92 that is oriented towards the pin head 88 wherein the pin shoulder 92 radially supports the preload element 64 which receives the pin section 86 and which is supported at a support surface 94 of the pin head 88 that is oriented away from the head surface 90. Thus, the pin 44 is configured to support the preload element 64 in an axial direction and in a radial direction.

A diameter DV of the preload element 64 is smaller than the diameter DK and thus greater than the diameter DS so that a secured and free movability of the preload element 64 is enabled, which is configured in this embodiment in a cost effective manner as a coil spring.

The pin head 88 is configured to contact the cover 48. Thus, the cover 48 is configured semi hollow cylindrical wherein a first element face 80 is configured flat and so that it extends over an entire first diameter D1. This enables a more economical production of the cover 48 compared to the prior art cover 48 which has two diameters D1, D2 and two receiving openings 50, 52.

The spherical pin head 88 provides a point contact for optimum force transmission between the cover 48 and the pin 44. By the same token the pin head 88 can also be configured to provide a line contact. The first element face 80 which is in contact with the pin 44 can also be configured convex cambered or spherical wherein the head surface 90 is advantageously configured flat in this case.

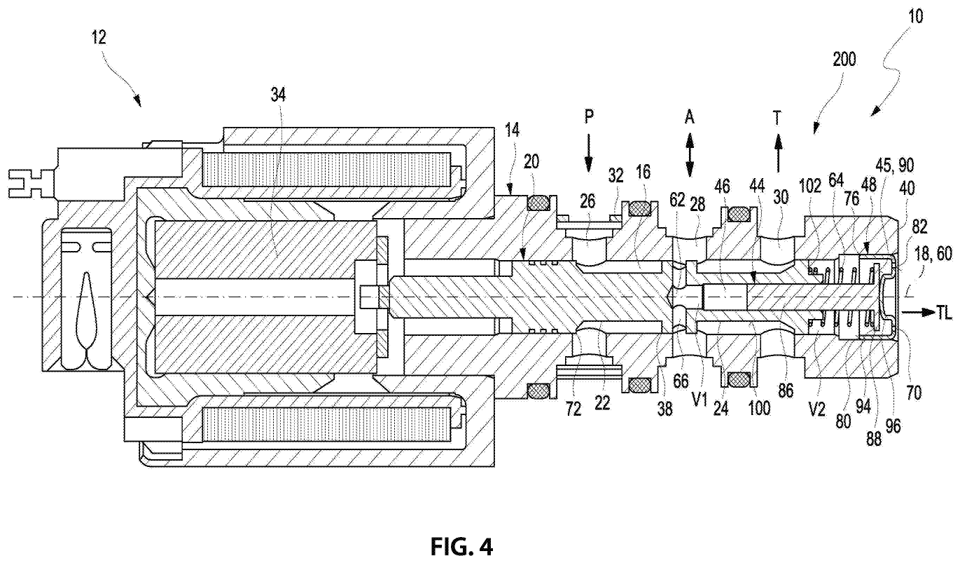

A comparable second embodiment of the electromagnetic pressure control valve 10 according to the invention is illustrated in FIG. 4. The cover 48 is configured so that it can receive at least the pin head 88 with the preload element 64 that is configured at the pin head 88. The head surface 90 is configured flat and contacts a convex inner shoulder 96 of the cover 48 that is configured in the receiving opening 50. The cover 48 includes the relief opening 70 wherein a relief opening is arranged that is flow connected with the second volume V2.

In the instant second embodiment the cover 48 is produced by an economical deep drawing method, wherein the inner shoulder 96 can be configured in a simple manner so that the receiving opening 52 is provided for receiving the clamping elements 54.

The cover 48 of the pressure control valve 10 configured according to the second embodiment includes the relief opening 70 which is a flowable connection of the first receiving opening 16 with a leakage tank connection TL. The relief flow opening 70 helps to drain leakage fluid, in particular during a movement of the piston 20 to provide a flow connection between the tank connection P and the supply connection A.

In the second embodiment the preload element 64 is configured supported at a shoulder 102 that is configured at an enveloping surface 100 of the piston 20. When the piston 20 is moved in a direction towards the cover 48 the shoulder 102 is receivable in a receiving opening 50 that is oriented towards the pin 44.

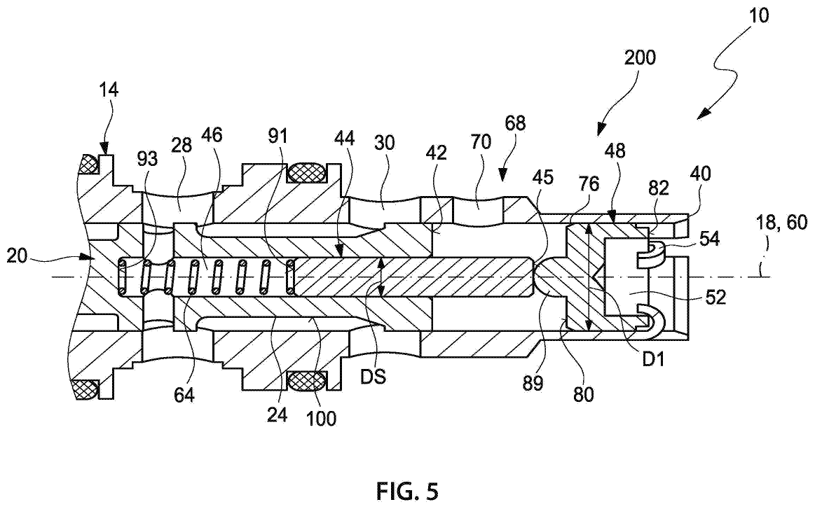

FIG. 5 illustrates a detail of a third embodiment. Differently from the first embodiment according to FIG. 2 the pin 44 is configured cylindrical without pin head or pin shoulder and contacts the stop 48 with its face 45. Put differently the pin 44 includes a single diameter DS. The stop 48 includes a convex protrusion 89 at an element face 80. The protrusion 89 can be configured integrally in one piece at the stop 48. However, it is also conceivable to fit e.g. a sphere into the stop 48 or a protrusion of the stop 48 in order to establish a point or line contact between the pin 44 and the stop 48 in order to reduce hysteresis influences e.g. from angular misalignments between the stop 48 and the pin 44.

As evident from FIG. 5 the pin 44 is also supported axially movable in the second receiving bore hole 46 in this embodiment. As another differentiating feature the preload element 64 for preloading the pin 44 does not envelop the pin 44 but is positioned between the piston 20 and the pin 44 in the second receiving bore hole 46. Thus, the preload element 64 contacts an additional face 91 that is oriented away from the stop 48 and a base 93 of the second receiving bore hole 46.

In addition to preloading the pin 44 the preload element 64 moves the piston 20 into an idle or starting position when the electromagnetic actuator is not loaded with current.

An additional non-illustrated spring element can be provided which preloads the piston 20 arranged between the piston 20 and the stop 48 directly or indirectly.

What is claimed is:

1. An electromagnetic pressure control valve, comprising:
an electromagnetic actuator configured to position a piston that is received axially movable in a receiving opening of a controller housing,
wherein the piston facilitates opening or closing flow connections of the electromagnetic pressure control valve,
wherein the piston includes a pin at a face that is oriented away from the electromagnetic actuator,
wherein a relative movement is enabled between the pin and the piston,
wherein a surface of the pin that is arranged in the controller housing and oriented away from the piston is arranged opposite to a stop,
wherein the pin is spring loaded to contact the stop so that a movement of the pin in a direction towards the stop is prevented, and
wherein a preload element that is configured to provide the spring loading engages the pin.

2. The electromagnetic pressure control valve according to claim 1, wherein the preload element is supported at the piston and at the pin.

3. The electromagnetic pressure control valve according to claim 1, wherein the preload element envelops the pin.

4. The electromagnetic pressure control valve according to claim 1,
wherein the pin includes at least a first diameter and a second diameter,
wherein the first diameter is smaller than the second diameter, and
wherein the second diameter is associated with a pin head or a pin shoulder where the preload element is supported.

5. The electromagnetic pressure control valve according to claim 4, wherein the pin head contacts the stop in a contact.

6. The electromagnetic pressure control valve according to claim 5, wherein the contact is configured as a punctiform contact or a line contact.

7. The electromagnetic pressure control valve according to claim 4, wherein the pin head is configured spherical or convex towards the stop.

8. The electromagnetic pressure control valve according to claim 1,
wherein the pin has a first diameter and is supported with a first pin face at the stop and with a second pin face at the preload element, and
wherein the preload element is positioned between the piston and the pin.

9. The electromagnetic pressure control valve according to claim 8, wherein the stop includes a spherical or convex protrusion configured to contact the pin.

10. The electromagnetic pressure control valve according to claim 1, wherein the pin or the stop are made from a synthetic material.

11. The electromagnetic pressure control valve according to claim 1,
wherein a variable volume is configured between the stop and the face of the piston that is oriented away from the actuator and towards the stop, and
wherein a relief opening that is flowable by the varible volume is configured at the controller housing.

12. The electromagnetic pressure control valve according to claim 1, wherein the stop includes a flowable opening.

13. The electromagnetic pressure control valve according to claim 1, wherein a relief opening that is configured at the controller housing is positioned as a function of an installation position of the electromagnetic pressure control valve.

14. The electromagnetic pressure control valve according to claim 1, wherein the stop is configured as a cover that closes the receiving opening of the controller housing.

15. The electromagnetic pressure control valve according to claim 14, wherein the cover includes a bevel at an outer circumference at a cover face that is oriented towards the pin.

16. The electromagnetic pressure control valve according to claim 14, wherein the cover is secured at the controller housing by at least one clamping element.

17. The electromagnetic pressure control valve according to claim 14, wherein a face of the cover that is oriented away from the piston is configured rounded.
